(19) United States
(12) Patent Application Publication
(10) Pub. No.: US 2020/0084979 A1
(43) Pub. Date: Mar. 19, 2020

(54) STUMP PLANER

(71) Applicant: James Trischler, Bay City, MI (US)

(72) Inventor: James Trischler, Bay City, MI (US)

(21) Appl. No.: 16/131,107

(22) Filed: Sep. 14, 2018

(51) Int. Cl. A01G 23/06

(52) U.S. Cl. CPC A01G 23/067; B27C 1/14

(57) ABSTRACT

A stump planer for use in stump planeing in environmentally sensitive areas.

### BACKGROUND OF THE INVENTION

The applicant is unaware of any prior art relating to this device.

### THE INVENTION

The present invention is a stump planer. The stump planer comprises a welded metal framework comprised of two side panels and separator bars.

The side panels are oppositely opposed to each other at a predetermined distance apart and the side panels have an inside top edge, an inside bottom edge, an inside back edge, an inside front edge, and an inside front diagonal edge. The side panels are securely held apart by separator bars. The separator bars are located, one near the inside top edges, and a second one near the inside bottom edges.

There is a depth gauge. The depth gauge is a third solid bar located near the inside bottom edges and near the inside front edges.

There is a knife holder plate. The knife holder plate is located near the inside bottom edges near the inside diagonal edges extending from the inside diagonal edges to the inside bottom edges. The knife holder plate has a back ridge thereon for stabilizing a knife. The knife holder plate has a channel in a top surface therein that extends from a first side to a second side.

The knife is detachably surmounted on the knife holder plate, such that a cutting edge of the knife is directed towards the depth gauge. The knife has at least two babbitt metal inserts detachably attached to a back edge of the knife.

Another embodiment is a stump planer wherein the distance between the depth gauge and the knife edge has a value of from ¼ inches to 2 inches.

A further embodiment is a stump planer where the channel is deep enough in the surface of the knife holder plate to allow fasteners to be mounted therein without extending above the top surface of the knife holder plate.

And yet another embodiment is a stump planer where the means of attaching the knife to the knife holder plate is bolts and nuts.

### BRIEF DESCRIPTION OF THE DRAWINGS

FIG. 1 is a view in perspective of the stump planer.

FIG. 2 is a full front view of the stump planer.

FIG. 3 is a full side view of the stump planer showing the planer mechanism in phantom.

FIG. 4 is a full side view of the planer mechanism.

FIG. 5 is a full top view of the knife and babbitts.

FIG. 6 is a full top view of the babbitts.

FIG. 7 is a top view of the top plate with openings.

### DETAILED DESCRIPTION OF THE DRAWINGS

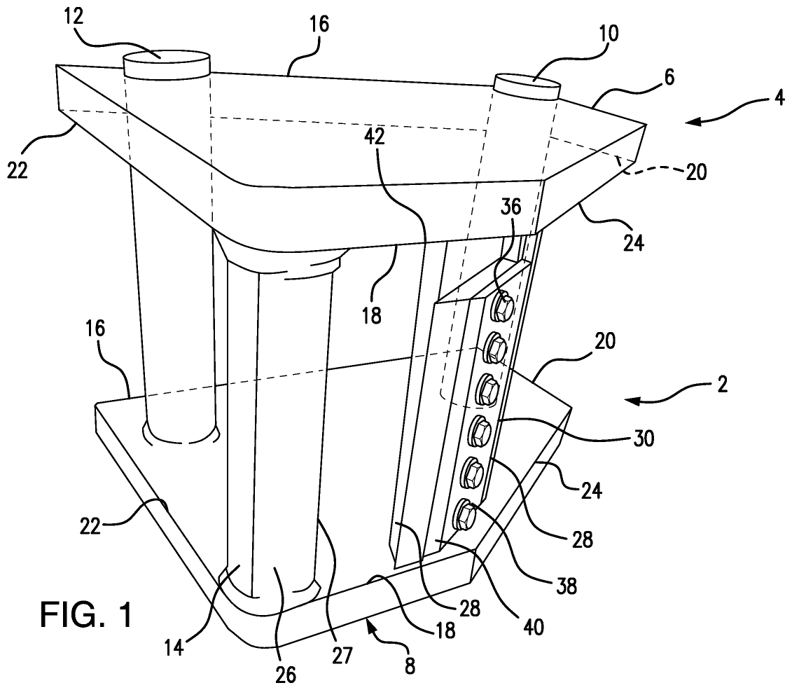

Turning now to FIG. 1 which is a view in perspective of the stump planer 2, it is comprised of a welded metal framework 4 with two side panels 6 and 8. There is also three separator bars, first separator bar 10, the second separator bar 12, and the third separator bar 14.

The first side panel 6 and the second side panel 8 are oppositely opposed to each other at a predetermined distance apart and these side panels 6 and 8 have an inside top edge 16, an inside bottom edge 18, an inside back edge 20, an inside front edge 22, and an inside front diagonal edge 24. The side panels 6 and 8 are securely held apart by the separator bars 10, 12 and 14. The first separator bar 10 is located near the inside top edges 16 and a second separator bar 12 is located near the inside bottom edges 18.

There is a depth gauge 26. The depth gauge 26 is the front edge 27 of the third separator bar 14 located near the inside bottom edges 18 and near the inside front edges 22. The distance between said depth gauge and said knife edge has a value of from ¼ inches to 2 inches.

There is a knife holder plate 28. The knife holder plate 28 is located near the inside bottom edges 16 near the inside diagonal edges 24 extending from the inside diagonal edges 24 to the inside bottom edges 16. The knife holder plate 28 has a back ridge 30 thereon for stabilizing a knife 40. The knife holder plate 28 has a channel 32 in a top surface 34 therein that extends from a first side 36 to a second side 38.

The knife 40 is detachably surmounted on the knife holder plate 28, such that a cutting edge 42 of the knife 40 is directed towards the depth gauge 26. The knife 40 has at least two babbitt metal inserts 44 detachably attached to a back edge 43 of the knife 40.

The stump planer 2 is attached to equipment that has a hydraulically driven boom. Such equipment would include an excavator or backhoe for example. The depth gauge 26 of the stump planer 2 is placed against the top and back of the stump and drawn toward the operator. It has been discovered that this motion of drawing the stump planer 2 toward the operator will systematically remove the stump without disturbing the surrounding soil. The stump planer 2 is designed to remove stumps from environmentally sensitive areas without disturbing the natural surroundings that stump removal devices cause. Sensitive areas would include river and ditch banks that should be left intact to prevent erosion and particulate materials from entering the watershed.

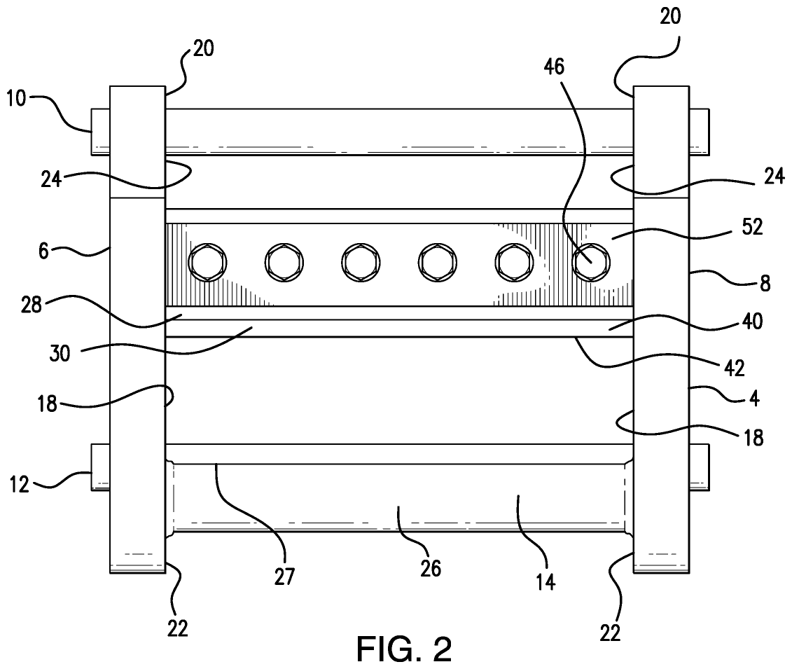

FIG. 2 shows the stump planer 2 from the front. Again, the stump planer 2 has a welded metal framework 4 that has a first side panel 6 and a second side panel 8. There are three separator bars 10,12 and 14. The first separator bar 10 and the second separator bar 12 separate the first side panel 6 from the second side panel 8. Both separator bars 10 and 12 also allow for the connection points for the stump planer 2 to connect to the desired equipment for use. The side panels 6 and 8 have an inside top edge 16, an inside bottom edge 18, an inside back edge 20, an inside front edge 22, and an inside front diagonal edge 24.

The knife holder plate 28 has a back ridge 30 thereon for stabilizing a knife 40. Also shown is the cutting edge 42 of the knife 40. The fasteners 46 are also visible.

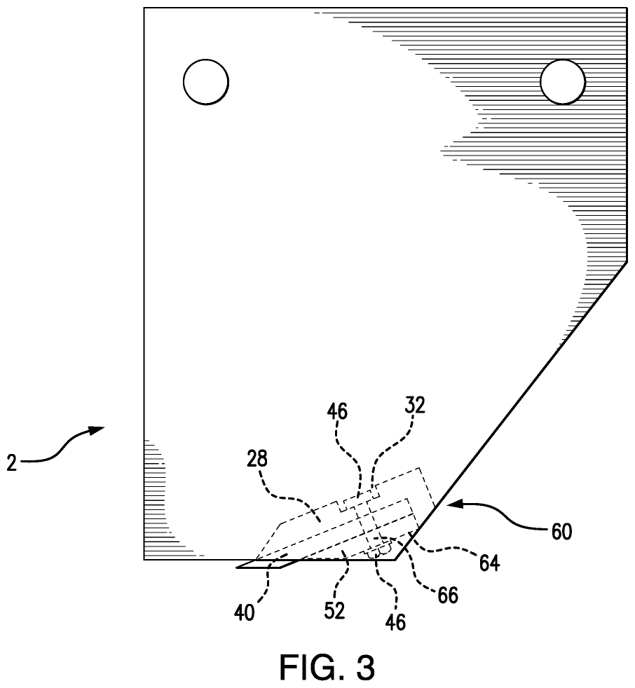

FIG. 3 shows the stump planer 2 from the side with the planer mechanism 60 in phantom. The knife holder plate 28 is clear as well as the back ridge 30. The channel 32 is also visible. It is shown how the knife holder plate 28 and the top plate 52 hold the knife 40 in place by fasteners 46 that go from the top surface 64 of the top plate 52 through openings therethrough 48 through oval openings 50 (not shown) of the knife 40 into the knife holder plate 28 and a fastener 46 secures the top plate 50, knife 40 and the knife holder plate 28 together forming the planer mechanism 60.

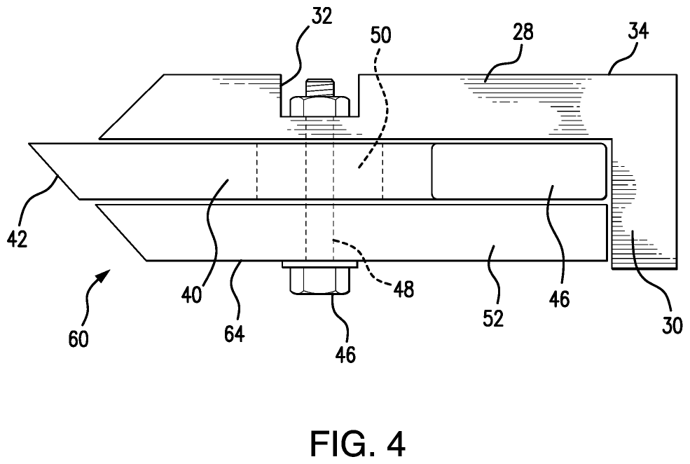

FIG. 4 shows the planer mechanism 60 from the side. The knife holder plate 28 and the back ridge 30 hold the knife 40 sandwiched between the knife holder 28 with the back ridge 30 and the top plate 52. They are held in place by the fastener 46 which passes through an opening therethrough 48 the top surface 64 of the top plate 52. The fastener 46 passes through an oval openings therethrough 50 (shown in phantom) of the knife 40. The fastener 46 is tightened by the other fastener 46 in the channel 32 in the top surface 34 of the knifer holder plate 28. There are two metal babbitts 44 between the back ridge 30 and inserted into the back end 70 of the knife 40 that act as spacers to allow a constant distance of the knife leading edge to the depth gauge.

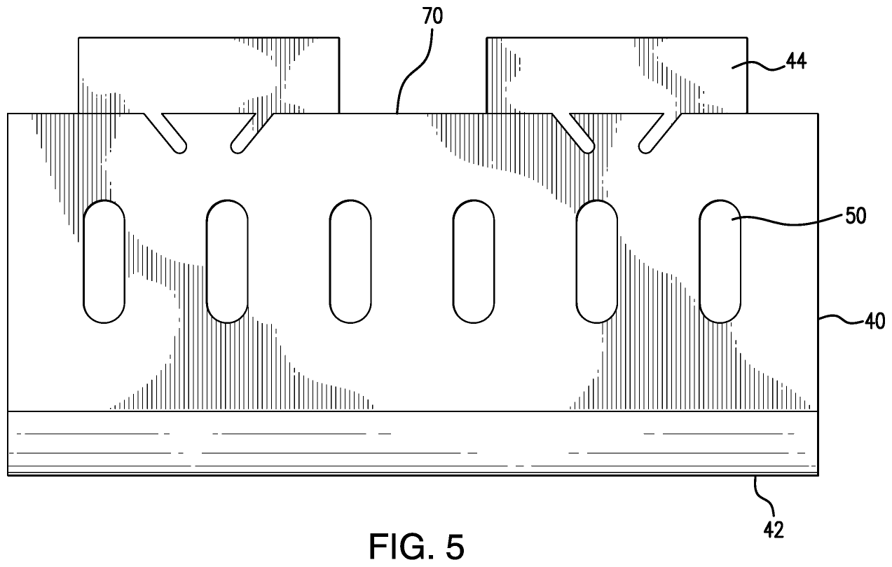

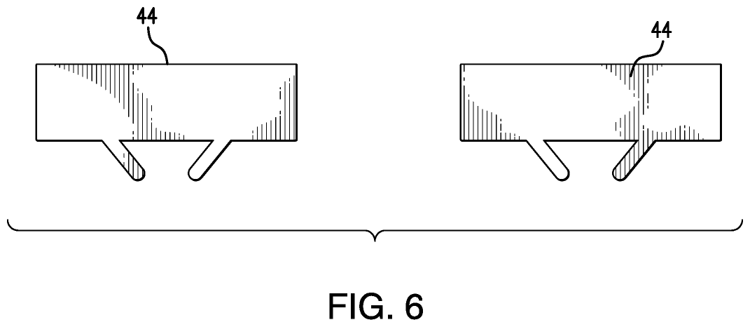

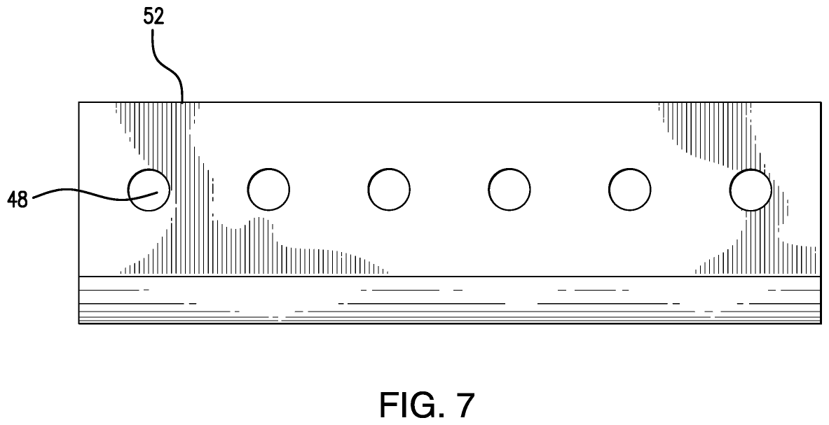

FIG. 5 shows the knife 40 and babbitts 44 from the top. The babbitts 44 are inserted into the back end 70 of the knife 40 and act as spacers. Also visible is the cutting edge 42 and the oval openings therethrough 50. FIG. 6 shows the babbitts 44 from the front. FIG. 7 shows the top plate 52 with openings therethrough 48.

The stump planer 2 generally has a distance between the depth gauge 26 and the cutting edge 42 of from ¼ inches to 2 inches.

The stump planer 2 has a knife holder plate 28 that has channel that is deep enough in the top surface 34 of the knife holder plate 28 to allow fasteners 46 to be mounted therein without extending above the top surface 34 of the knife holder plate 28.

The stump planer 2 has the means of attaching the knife 40 to the knife holder plate 28 is bolts and nuts. The stump planer 2 is manufactured from metal, that is, steel. That metal can also be cast iron.

What is claimed is:

1. A stump planer, said stump planer comprising a welded metal framework comprised of two side panels and separator bars;
said side panels being oppositely opposed to each other at a predetermined distance apart and said side panels having an inside top edge, an inside bottom edge, an inside back edge, an inside front edge, and an inside front diagonal edge, said side panels being securely held apart by said separators bars, said separator bars being located, one near the inside top edges and a second one near the inside bottom edges;
a depth gauge, said depth gauge being a third solid bar located near said inside bottom edges and near said front edges;
a knife holder plate, said knife holder plate being located near said inside bottom edges near said diagonal edges extending from said diagonal edges to said inside bottom edges, said knife holder plate having a back ridge thereon for stabilizing a knife, and said knife holder plate having a channel in a top surface therein, extending from a first side to a second side;
said knife detachably surmounted on said knife holder plate, such that a cutting edge of said knife is directed towards said depth gauge, said knife having at least two babbitt metal inserts detachably attached to a back edge of said knife.

2. The stump planer as claimed in claim 1 wherein the distance between said depth gauge and said knife edge has a value of from ¼ inches to 2 inches.

3. The stump planer as claimed in claim 1 wherein the channel is deep enough in the surface of the knife holder plate to allow fasteners to be mounted therein without extending above the top surface of the knife holder plate.

4. The stump planer as claimed in claim 1 wherein the means of attaching said knife to said knife holder plate is bolts and nuts.

5. The stump planer as claimed in claim 1 wherein the metal is steel.

6. The stump planer as claimed in claim 1 wherein the metal is cast iron.
